(19) United States
(12) Patent Application Publication
(10) Pub. No.: US 2004/0147268 A1
(43) Pub. Date: Jul. 29, 2004

(54) Position location for wap mobile entity

(76) Inventors: Joe Jensen, Aalborg (DK); Robert Aston Dive, West Sussex (GB); Dan Van The, Aalborg (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/475,339

(22) PCT Filed: Apr. 12, 2002
(86) PCT No.: PCT/IB02/02172

(30) Foreign Application Priority Data
Apr. 20, 2001 (GB) 0109823.5

(51) Int. Cl. H04Q 7/20

(52) U.S. Cl. 455/456.1; 455/404.2

(57) ABSTRACT

There is disclosed a method of identifying the location of a mobile entity supporting WAP functionality, comprising: transmitting a request for location information from an origin server to the mobile entity, receiving the location information from the mobile entity.

### FIELD OF THE INVENTION

The present invention relates to identifying the location of a mobile entity, and particularly but not exclusively to the identification of such location in a wireless application protocol (WAP) environment.

### BACKGROUND TO THE INVENTION

The advent of wireless application protocol (WAP) mobile entities, and particularly mobile telephones, has led to an increase in demand for internet-type services to be provided to mobile devices. Service operators and content providers offer internet type services to mobile telephone users utilizing WAP technology.

Such operators and content providers are particularly seeking to provide content information that is particularly suited to mobile device applications. For example, if a content provider is able to identify the current location of a mobile telephone, then the content provided to that mobile telephone can be modified as appropriate to reflect local information.

The aim of this invention is to provide an efficient technique for providing location information to a content provider.

### SUMMARY OF THE INVENTION

The present invention provides the content develop/server or origin server with a simple and easy to use interface to obtain location information from the handset utilising WAP functionality. No additional interfaces are needed in the case of a system utilising a WAP gateway and a location server.

In accordance with the present invention there is provided a method of utilising location based services in a mobile entity supporting mobile browsing functionality, comprising: transmitting a request for location information from an origin server to the mobile entity; collecting the location information at the mobile entity; receiving the location information from the mobile entity at the origin server; and transmitting location based information, wherein the location information received at the origin server is a Wireless Markup Language Script function comprising: an identifier of a Universal Resource Locator of the origin server; an identifier of longitude and latitude of the mobile entity; and an identifer of a place name in which the mobile entity is located.

The method may further comprise the step of selecting enhanced services responsive to receiving the location information.

The location based information may comprise a location based service. The location based service may comprise content.

The mobile browsing functionality may comprise WAP functionality.

The request may be transmitted in a WMLScript.

The location information may comprise mobile network information.

The mobile network information may be converted into location information.

The mobile network information may be converted into location information utilising a mobile internet gateway and a location server.

The mobile entity may include GPS functionality. The GPS information may be enhanced into location information utilising a mobile internet gateway and a location server.

The present invention further provides a mobile communications system including a mobile entity supporting mobile browsing functionality and connected in a wireless network and a service provider connected to the Internet, wherein the mobile entity collects location information and provides such to the service provider responsive to a request therefrom, and wherein the location information provided to the service provider is a Wireless Markup Language Script function comprising: an identifier of a Universal Resource Locator of the origin server; an identifier of longitude and latitude of the mobile entity; and an identifer of a place name in which the mobile entity is located.

The service provider may comprise a content provider.

The mobile communication system may further comprise means for selecting enhanced services responsive to receiving the location information

The mobile communications system may further include a mobile internet gateway, wherein the location information and the request therefore are transmitted via a mobile internet gateway.

The mobile communications system may further comprise a location server connected to the mobile internet gateway.

The mobile entity may have mobile network functionality, wherein the mobile entity provides mobile network information identifying its location, the mobile network information being received by the gateway, and converted into location information by the location server.

The location information may be in format identifying place names.

The invention still further provides a mobile internet gateway having an interface to a wireless network supporting mobile browsing enabled mobile devices and an interface to the internet, wherein the gateway receives a request from an origin server for location information of a mobile device connected in the wireless network, and forwards such to the mobile device, and receives location information from the mobile device and forwards such to the origin server, wherein the location information forwarded to the origin server is a Wireless Markup Language Script function comprising: an identifier of a Universal Resource Locator of the origin server; an identifier of longitude and latitude of the mobile entity; and an identifer of a place name in which the mobile entity is located.

The location information received may be in the form of mobile network information, wherein the gateway provides the mobile network information to a location server which returns location in a format suitable for transmission to a device connected to the internet.

The gateway may comprise a WAP gateway.

The format may be place names.

The mobile entity may support GPS and the location information is provided directly from the mobile entity to a device connected to the internet.

The device connected to the internet may be a content provider.

### BRIEF DESCRIPTION OF THE DRAWINGS

The invention will now be described by way of reference to the accompanying drawings, in which:

FIG. 1 illustrates elements of a network for implementation of an embodiment of the present invention; and

FIG. 2 illustrates an exchange of messages in accordance with an embodiment of the invention.

### DESCRIPTION OF PREFERRED EMBODIMENTS

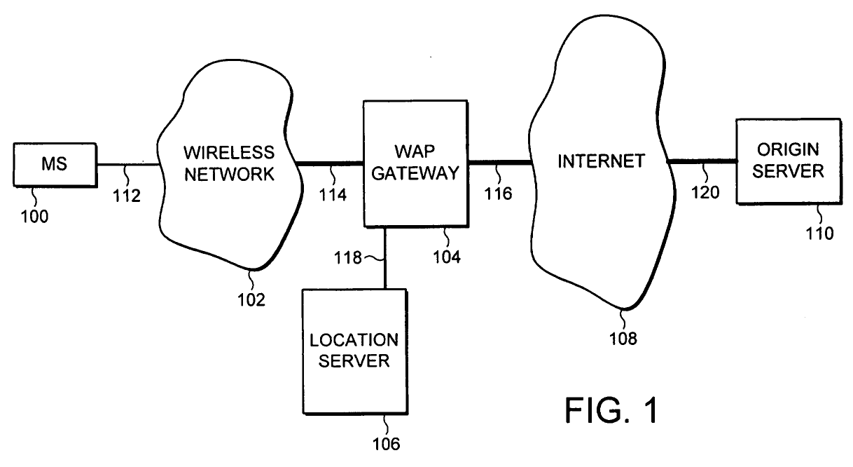

Referring to FIG. 1, there is illustrated an exemplary scenario within which the invention is described herein. It should be noted however that the invention is not limited to such an exemplary scenario.

A mobile station 100, preferably a WAP enabled GSM mobile telephone, is connected to a wireless network 102, preferably a GSM network, via a wireless connection 112. The wireless network 102 is connected to a WAP gateway 104 via a connection 114. The WAP gateway is in turn also connected to the Internet 108 via a connection 116. An origin server 110, forming a content provider, connects to the internet 108 via a connection 120. The WAP Gateway 104 is further connected to a location sever 106.

All the elements of FIG. 1 are known, and their function in so far as it relates to the invention is described in further details hereinbelow. The location server is a network entity that performs the actual mapping between network information and location information.

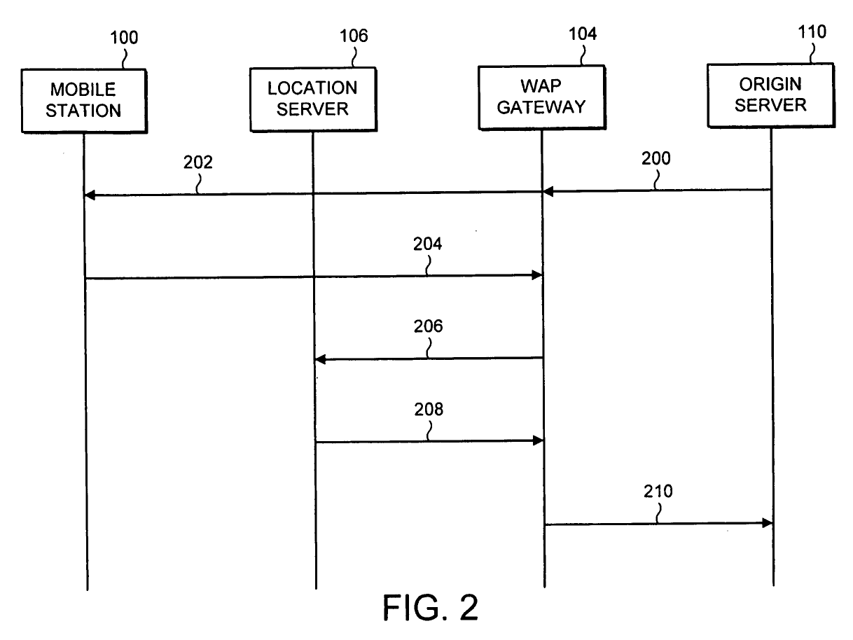

Referring to FIG. 2, the operation of the present invention will be described with reference to the example scenario. It should be noted that in the described example it is assumed that the mobile station 100 is already connected to the origin server 110 in accordance with standard techniques, and makes a request for services from the origin server 110.

Responsive to the request for services, the origin server 110 sends a response to the mobile station. As represented by arrow 200, a response message is sent from the origin server and intercepted by the WAP gateway 104. The WAP gateway 104 encodes the message into a suitable format, and forwards the response message to the mobile station 100 as represented by arrow 202. In accordance with the present invention, the message sent to the mobile station by way of response includes a request for location information.

Responsive to receipt of the request for location information contained in the response message, the mobile station collects appropriate data. In the described example, of a GSM mobile telephone, the mobile station collects appropriate GSM data. In alternative arrangements, such as where GPS functionality is provided, alternative data collection may be performed.

After collection of the location data, the mobile station sends a new request message as represented by arrow 204. The new request message contains the collected location data in a pre-defined HTTP header.

The WAP gateway intercepts the message 204, which is destined for the origin server 110, based on the HTTP header. The WAP gateway 104 then issues a request message 206 to the location server 106 over the connection 118, which is preferably an XML interface. The location server is requested to resolve the location of the mobile station 100 based on the handset data collected by the mobile station and contained in the message 204.

Responsive thereto the location server 106 provides the WAP gateway 104 with the resolved location in a message 208. Where the information provided by the mobile entity is GSM information, the resolved location is, for example, the longitude and latitude resolved from the GSM information. Alternatively GIS (Geographical Information System), such as the city and street may be resolved from the longitude and latitude. This information may be resolved based on GSM network information such as Cell ID and Timing Advance. In an example where the collected data is GPS data, the location server may format the data for longitude and latitude, or the functionality of the WAP Gateway and the server may be dispensed with.

Where the information collected by the mobile device is GSM data, the use of a WAP gateway to intercept the data and the location server to convert the information prior to forwarding the data to the origin server is essential where the information collected by the mobile device is GPS data the use of the WAP gateway and the location server is not essential. However in such a case the use of the WAP gateway and the location server will enhance the information returned to the origin server.

The WAP gateway then provides the location information to the origin server 110 in a message as represented by arrow 210. The information is provided by substituting the headers of the message 204.

Once the origin server 110 is provided with the location information identifying the position of the device, the origin server can provide location specific content to the mobile entity.

The invention thus provides a new script function, which is a WMLS function, to transport the location of the WAP device to the content provider based on location information from either a mobile network or a specific location system such as GPS.

The technique is applicable not only to GSM or GPRS networks but also to the future development of TDMA and CDMA based mobile communications systems like UMTS and CDMA2000. The new function may be known as the location information function, abbreviated to LocationInfo( ). The format of the function may be as follows:

LocationInfo(URL, LL-format, PN-format)

Where:

URL: This is the URL that receives the location information;

LL-format: This is the format and accuracy of the longitude/latitude (degrees, minutes etc); and

PN-format: This is the format for place names, for example country, zip code, street address etc.

In accordance with the present invention, the location information function, usable by any content provider, obtains the position of a mobile device through a gateway.

In the example of FIGS. 1 and 2, the WAP gateway 104 is preferably a Nokia Artuse WAP Gateway, and the location server 106 is preferably a Nokia Artuse Location Server.

1. A method of utilising location based services in a mobile entity supporting mobile browsing functionality, comprising: transmitting a request for location information from an origin server to the mobile entity; collecting the location information at the mobile entity; receiving the location information from the mobile entity at the origin server; and
transmitting location based information, wherein the location information received at the origin server is a Wireless Markup Language Script function comprising:
an identifier of a Universal Resource Locator of the origin server;
an identifier of longitude and latitude of the mobile entity; and
an identifer of a place name in which the mobile entity is located.

2. The method of claim 1 further comprising the step of selecting enhanced services responsive to receiving the location information.

3. The method of claim 1 or claim 2 wherein the location based information comprises a location based service.

4. The method of any one of claims 1 to 3 wherein the location based service comprises content.

5. The method of any one of claims 1 to 4 wherein the mobile browsing functionality comprises WAP functionality.

6. The method of any one of claims 1 to 5 wherein the request is transmitted in a WMLScript.

7. The method of any one of claims 1 to 6 wherein the location information comprises mobile network information.

8. The method of claim 7 wherein the mobile network information is converted into location information.

9. The method of claim 8 wherein the mobile network information is converted into location information utilising a mobile internet gateway and a location server.

10. The method of any one of claims 1 to 6 wherein the mobile entity includes GPS functionality.

11. The method of claim 10 wherein the GPS information is enhanced into location information utilising a mobile internet gateway and a location server.

12. A mobile communications system including a mobile entity supporting mobile browsing functionality and connected in a wireless network and a service provider connected to the Internet, wherein the mobile entity collects location information and provides such to the service provider responsive to a request therefrom, and wherein the location information provided to the service provider is a Wireless Markup Language Script function comprising:
an identifier of a Universal Resource Locator of the origin server;
an identifier of longitude and latitude of the mobile entity; and
an identifer of a place name in which the mobile entity is located.

13. A mobile communications systems of claim 12, wherein the service provider comprises a content provider.

14. The mobile communication system according to any of claims 12 to 13 further comprising means for selecting enhanced services responsive to receiving the location information.

15. The mobile communications system of any one of claims 12 to 14 wherein the system further includes a mobile internet gateway, wherein the location information and the request therefore are transmitted via a mobile internet gateway.

16. The mobile communications system of claim 15 wherein the system further comprises a location server connected to the mobile internet gateway.

17. The mobile communication system of any one of claims 12 to 16 in which the mobile entity has mobile network functionality, wherein the mobile entity provides mobile network information identifying its location, the mobile network information being received by the gateway, and converted into location information by the location server.

18. The mobile communication system of claim 17 wherein the location information is in format identifying place names.

19. A mobile internet gateway having an interface to a wireless network supporting mobile browsing enabled mobile devices and an interface to the internet, wherein the gateway receives a request from an origin server for location information of a mobile device connected in the wireless network, and forwards such to the mobile device, and receives location information from the mobile device and forwards such to the origin server, wherein the location information forwarded to the origin server is a Wireless Markup Language Script function comprising:
an identifier of a Universal Resource Locator of the origin server;
an identifier of longitude and latitude of the mobile entity; and
an identifer of a place name in which the mobile entity is located.

20. The mobile internet gateway of claim 19 in the location information received is in the form of mobile network information, wherein the gateway provides the mobile network information to a location server which returns location in a format suitable for transmission to a device connected to the internet.

21. The mobile internet gateway according to claims 20 or 21, wherein the gateway comprises a WAP gateway.

22. The gateway of claims 20 or 21 wherein the format is place names.

23. The gateway of claim 20 or 21 in which the mobile entity supports GPS and the location information is provided directly from the mobile entity to a device connected to the internet.

24. The gateway of any one of claims 20 to 23 wherein the device connected to the internet is a content provider.
